(19) United States
(12) Patent Application Publication
(10) Pub. No.: US 2020/0160631 A1
(43) Pub. Date: May 21, 2020

(54) METHOD AND APPARATUS FOR ESTIMATING CAPACITY OF A PREDETERMINED AREA OF A VEHICLE

(71) Applicant: NEC CORPORATION, Tokyo (JP)

(72) Inventors: Hui Lam ONG, Singapore (SG); Cheng LIU, Singapore (SG); Yuki KAMIYA, Singapore (SG)

(73) Assignee: NEC CORPORATION, Tokyo (JP)

(21) Appl. No.: 16/627,876

(22) PCT Filed: May 31, 2018
(86) PCT No.: PCT/JP2018/020903

§ 371 Date: Dec. 31, 2019

(30) Foreign Application Priority Data
Jul. 3, 2017 (SG) 10201705461Q

(51) Int. Cl. G07C 5/10; G08G 1/01; B61L 27/00

(52) U.S. Cl. CPC G07C 5/10; G08G 1/0129; B61L 27/0011; B61L 27/0094; G08G 1/0116

(57) ABSTRACT

In a first aspect, there is provided a method, by a server (102, 120), for adaptively estimating capacity of a predetermined area of a vehicle, comprising: receiving, by the server (102, 120), information relating to at least one individual who is positioned at an entrance to enter the predetermined area of the vehicle; determining, by the server, if the at least one individual fails to enter the predetermined area of the vehicle at a location in response to receiving the information; and estimating, by the server (102, 120), the capacity of the predetermined area of the vehicle when it is determined that the at least one individual fails to enter the predetermined area of the vehicle.

### TECHNICAL FIELD

The present invention relates broadly, but not exclusively, to methods and apparatus for estimating capacity of a predetermined area of a vehicle.

### BACKGROUND ART

Traffic congestion is one of the biggest problems faced by many countries around the world. Public transport has been introduced not only to resolve traffic congestion but also allow everyone to travel without the need of owning private transport.

Huge infrastructure investment has been made by many economically developed countries with the intention to promote and maintain high quality of service in public transportation system which includes trains and buses. Investment of public transport infrastructure not only helps to relieve traffic congestion, but also makes the cities more environmentally friendly by lowering consumption of energy to transport per passenger from one location to another.

Human traffic congestion during peak hours has become a big challenge for public transports operators around the world as public transports are often regulated and measured by government to ensure its quality of service as many people rely heavily on it to perform their daily routines, be it study, work or leisure.

Many strategies and techniques are used by government and public transport operators to reduce human traffic congestion during peak hours which includes increasing the number or frequencies of transports to serve more passengers, acquiring bigger and longer model of the transports, optimizing schedule and operation to allow shorter waiting time between two transports and giving free or discounted rides hoping to spread out peak hours crowd.

### SUMMARY OF INVENTION

### Technical Problem

Analytics are often used to provide more insight to assist operators for better resource utilization and planning. There is lot of research and implementations that focus on in-cabin crowd density detection such as heat sensing, video analytics such as crowd estimation, counting or flow analysis, ticketing information and even Wi-Fi signals detection. As far as these ideas sound promising but they are still not mature and way too expensive for implementation as it requires a lot of system setup and calibration during deployment as well as hardware maintenance.

Moreover, they fail to address the need to estimate available capacity in a non-reserved transportation passenger vehicle since it is not possible to passengers to buy a ticket to reserve a seat in advance in that passenger vehicle.

A need therefore exists to provide methods for adaptively estimating capacity of a predetermined area of a vehicle that addresses one or more of the above problems.

Furthermore, other desirable features and characteristics will become apparent from the subsequent detailed description and the appended claims, taken in conjunction with the accompanying drawings and this background of the disclosure.

### Solution to Problem

In a first aspect, there is provided a method, by a server, for adaptively estimating capacity of a predetermined area of a vehicle, comprising: receiving, by the server, information relating to at least one individual who is positioned at an entrance to enter the predetermined area of the vehicle;

determining, by the server, if the at least one individual fails to enter the predetermined area of the vehicle at a location in response to receiving the information; and

estimating, by the server, the capacity of the predetermined area of the vehicle when it is determined that the at least one individual fails to enter the predetermined area of the vehicle.

In an embodiment, the step of estimating the capacity of the predetermined area of the vehicle comprises:

retrieving, by the server, historical data relevant to the vehicle at a successive location that is located after the location, the historical data indicating a number of passengers leaving the predetermined area of the vehicle at the successive location; and

predicting, by the server, a number of individuals leaving the predetermined area of the vehicle at the successive location in response to the historical data.

In an embodiment, the capacity of the predetermined area of the vehicle at the successive location is estimated in response to the prediction of the number of individuals leaving the predetermined area of the vehicle at the successive location.

In an embodiment, the step of determining if the at least one individual fails to enter the predetermined area of the vehicle at the location, comprises:

receiving, by the server, information indicating that the entrance to enter the predetermined area of the vehicle is closing, wherein the determination if the at least one individual fails to enter the predetermined area of the vehicle is performed in response to the receipt of the information indicating that the entrance to enter the predetermined area of the vehicle is closing.

In an embodiment, the step of determining if the at least one individual fails to enter the predetermined area of the vehicle at the location, comprises:

determining, by the server, if a number of individuals who fail to enter the predetermined area of the vehicle is above a threshold value when it is determined that the at least one individual fails to enter the predetermined area of the vehicle.

In an embodiment, the method further comprises sending the result of the estimation step to at least one other server that is operationally coupled to the server, the at least one other server being configured to estimate capacity of the predetermined area of the vehicle at the successive location that is located after the location.

In an embodiment, the method further comprises determining, by the at least one other server, a number of individuals who are positioned at an entrance to enter the predetermined area of the vehicle at the successive location.

In an embodiment, the method further comprises displaying, by the at least one other server, the result of the estimation step at the vehicle at the other successive location.

In an embodiment, the step of displaying the result of the estimation step comprises:

determining if the result of the estimation step is above a predetermined value; and

displaying the result of the estimation step in a predetermined format when it is determined that the result of the estimation step is above the predetermined value.

In a second aspect, there is provided an apparatus for adaptively estimating capacity of a predetermined area of a vehicle, the apparatus comprising:

at least one processor; and

at least one memory including computer program code;

the at least one memory and the computer program code configured to, with at least one processor, cause the apparatus at least to:

receive information relating to at least one individual who is positioned at an entrance to enter the predetermined area of the vehicle;

determine if the at least one individual fails to enter the predetermined area of the vehicle at a location in response to receiving the information; and

estimate the capacity of the predetermined area of the vehicle when it is determined that the at least one individual fails to enter the predetermined area of the vehicle.

In an embodiment, the at least one memory and the computer program code is further configured with the at least one processor to:

retrieve historical data relevant to the vehicle at a successive location that is located after the location, the historical data indicating a number of passengers leaving the predetermined area of the vehicle at the successive location; and

predict a number of individuals leaving the predetermined area of the vehicle at the successive location in response to the historical data.

In an embodiment, the at least one memory and the computer program code is further configured with the at least one processor to:

estimate the capacity of the predetermined area of the vehicle at the successive location in response to the prediction of the number of individuals leaving the predetermined area of the vehicle at the successive location.

In an embodiment, the at least one memory and the computer program code is further configured with the at least one processor to:

receive information indicating that the entrance to enter the predetermined area of the vehicle is closing,

wherein the determination if the at least one individual fails to enter the predetermined area of the vehicle is performed in response to the receipt of the information indicating that the entrance to enter the predetermined area of the vehicle is closing.

In an embodiment, the at least one memory and the computer program code is further configured with the at least one processor to:

determine if a number of individuals who fail to enter the predetermined area of the vehicle is above a threshold value when it is determined that the at least one individual fails to enter the predetermined area of the vehicle.

In an embodiment, the at least one memory and the computer program code is further configured with the at least one processor to:

send the result of the estimation step to at least one other server that is operationally coupled to the server, the at least one other server being configured to estimate capacity of the predetermined area of the vehicle at least one other successive location that is located after the location.

In an embodiment, the at least one memory and the computer program code is further configured with the at least one processor to:

determine a number of individuals who are positioned at an entrance to enter the predetermined area of the vehicle at the at least one other successive location.

In an embodiment, the at least one memory and the computer program code is further configured with the at least one processor to:

displaying the result of the estimation.

In an embodiment, the at least one memory and the computer program code is further configured with the at least one processor to:

send the result of the estimation to the at least one other server.

In an embodiment, the at least one memory and the computer program code is further configured with the at least one processor to:

determine if the result of the estimation is above a predetermined value; and

display the result of the estimation in a predetermined format when it is determined that the result of the estimation is above the predetermined value.

### Advantageous Effects of Invention

According to the embodiment, it is possible to provide methods for adaptively estimating capacity of a predetermined area of a vehicle that addresses one or more of the above problems.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a block diagrams of a system 100 within which capacity of predetermined area of a vehicle is estimated in accordance with embodiments of the invention.

FIG. 2 shows a flowchart illustrating a method 200 for adaptively estimating the capacity of the predetermined area of the vehicle in accordance with embodiments of the invention.

FIG. 3A shows an example as to how capacity of a predetermined area of a vehicle is adaptively estimated in accordance with embodiments of the invention.

FIG. 3B shows an example as to how capacity of a predetermined area of a vehicle is adaptively estimated in accordance with embodiments of the invention.

FIG. 3C shows an example as to how capacity of a predetermined area of a vehicle is adaptively estimated in accordance with embodiments of the invention.

FIG. 4 shows two examples as to how capacity of a predetermined area of a vehicle is adaptively estimated in accordance with embodiments of the invention.

FIG. 5 shows a flow chart illustrating how capacity of a predetermined area of a vehicle may be estimated in accordance with embodiments of the invention.

FIG. 6 shows an example as to how capacity of a predetermined area of a vehicle is adaptively estimated using a Markov model in accordance with embodiments of the invention.

FIG. 7 shows two examples as to how capacity of a predetermined area of a vehicle is adaptively estimated using a Markov model in accordance with embodiments of the invention.

FIG. 8A shows an example as to how capacity of a predetermined area of a vehicle is displayed in accordance with embodiments of the invention.

FIG. 8B shows an example as to how capacity of a predetermined area of a vehicle is displayed in accordance with embodiments of the invention.

FIG. 8C shows an example as to how capacity of a predetermined area of a vehicle is displayed in accordance with embodiments of the invention.

FIG. 9 shows an exemplary computing device that may be used to execute the method of FIG. 2.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “estimating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present invention relate to methods and apparatuses for estimating capacity of a predetermined area of a vehicle. In an embodiment, the method and apparatus estimate the capacity of the predetermined area of the vehicle when it is determined that the at least one individual fails to enter the predetermined area of the vehicle.

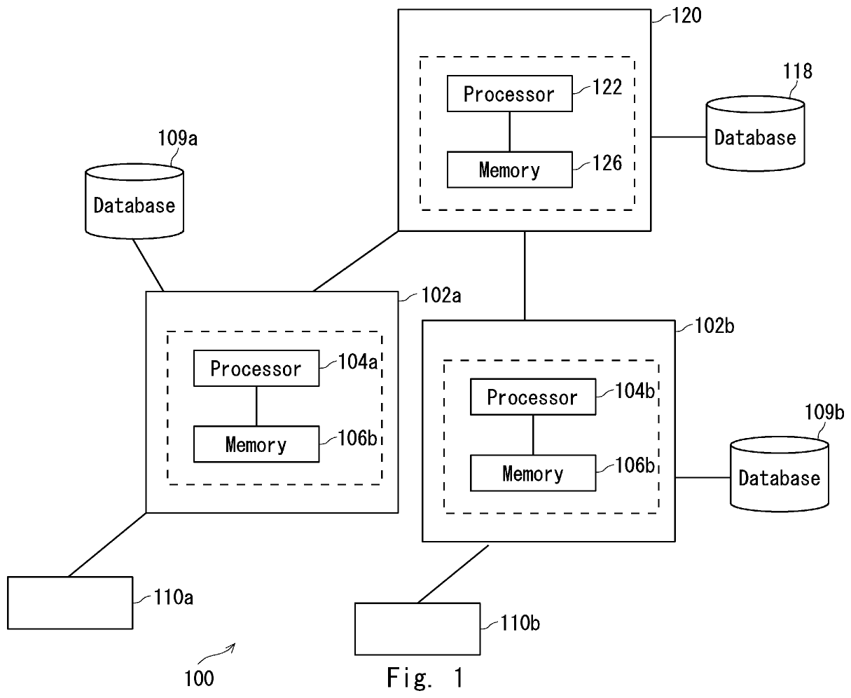

FIG. 1 shows a block diagrams of a system 100 within which capacity of predetermined area of a vehicle is estimated in accordance with embodiments of the invention. Referring to FIG. 1, provision of the estimation process involves a server 102 that is operationally coupled to at least one sensor 110. The sensor 110 is configured to detect and send information relating to at least one individual who is positioned at an entrance to enter the predetermined area. In an example, the individual is one who is standing in a designated area (e.g., a queue or a marked-up area) in from of an entrance (e.g., a gate) waiting to enter a predetermined area (e.g., cabin) of the vehicle (e.g., train or subway or metro or a non-reservation vehicle). The sensor 110 may be, among other things, include an image capturing device and a motion sensor and may be configured to detect arrival time and departure time of the vehicle at a location (e.g., a train station) The server 102 is configured to receive the information relating to the at least one individual.

The sensor 110 is capable of wireless communication using a suitable protocol with the server 102. For example, embodiments may be implemented using sensors 110 that are capable of communicating with WiFi/Bluetooth-enabled server 102. It will be appreciated by a person skilled in the art that depending on the wireless communication protocol used, appropriate handshaking procedures may need to be carried out to establish communication between the sensor 110 and the server 102. For example, in the case of Bluetooth communication, discovery and pairing of the sensor 110 and the server 102 may be carried out to establish communication.

In an example, an arrival time is recorded (or detected) at the sensor 110 when the vehicle (e.g., a train) approaches a first location (e.g., a train station). The sensor 110 may be configured to detect the presence of individuals at an entrance to enter a predetermined area of the vehicle. The detection may be triggered by the arrival of the vehicle or the opening of an entrance to the predetermined area. The sensor 110 is configured to detect the situation of individuals who would like to enter a cabin of the train. There may be a plurality of sensors 110a, 110b. Each of the plurality of sensors 110a, 110b which is operationally coupled to a different server 102a, 102b is configured to detect the information of individuals at an entrance of each cabin (or predetermined area). The sensor 110 may be configured to detect if an entrance is closing. The detection that the entrance is closing may trigger the sensor 110 to detect information relating to at least one individual who is positioned at an entrance and send the detected information to the server 102.

The server 102 may include a processor 104 and a memory 106. For example, the server 102a includes a processor 104a and a memory 106a. In embodiments of the invention, the memory 106 and the computer program code, with processor 104, are configured to cause the server 102 to receive information relating to at least one individual who is positioned at an entrance to enter the predetermined area of the vehicle, determine if the at least one individual fails to enter the predetermined area of the vehicle at a location in response to receiving the information; and estimate the capacity of the predetermined area of the vehicle when it is determined that the at least one individual fails to enter the predetermined area of the vehicle.

In various embodiments, a central server 120 is operationally coupled to a plurality of servers 102a, 102b. Each of the servers 102a, 102b is configured to adaptively estimate capacity of a predetermined area of the vehicle at a respective location. For example, the server 102a is configured to receive information relating to at least one individual who is positioned at an entrance to enter the predetermined area of the vehicle and determine if the at least one individual fails to enter the predetermined area of the vehicle at a location in response to receiving the information and determine that an estimation of the capacity of the predetermined area should be initiated. The results of the estimation will be sent to the server 102b which is located at the successive location (e.g., the next train station). For the following description, the successive location is not limited to the location that follows immediately after the first location.

The role of the server 102 or the main server 120 is to facilitate communication between the sensor 110 and the processor 122 or 102. Therefore, the server 102a, 102b may serve as a means through which the main server 120 may communicate with the sensor 101a, 101b in a manner that estimation of the capacity may be performed. That is, in an embodiment, the main server 120 may be the one which receive information relating to at least one individual who is positioned at an entrance to enter the predetermined area of the vehicle and determine if the at least one individual fails to enter the predetermined area of the vehicle at a location in response to receiving the information and determine that an estimation of the capacity of the predetermined area should be initiated. In specific implementations, the server 102a, 102b or the main server 120 may receive information relating to a number of individuals leaving the predetermined area of the vehicle at any location and subsequently store/update the information in the database 109a, 109b or the database 118, respectively.

The server 102a may be different and separate from the main server 120. In specific implementations, the server 102 or the main server 120 is further configured to perform additional operations. For example, the server 102 or the main server 120 may be configured to retrieve historical data and predict a number of individuals who may leave the predetermined area at a location in response to the retrieval of the historical data.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

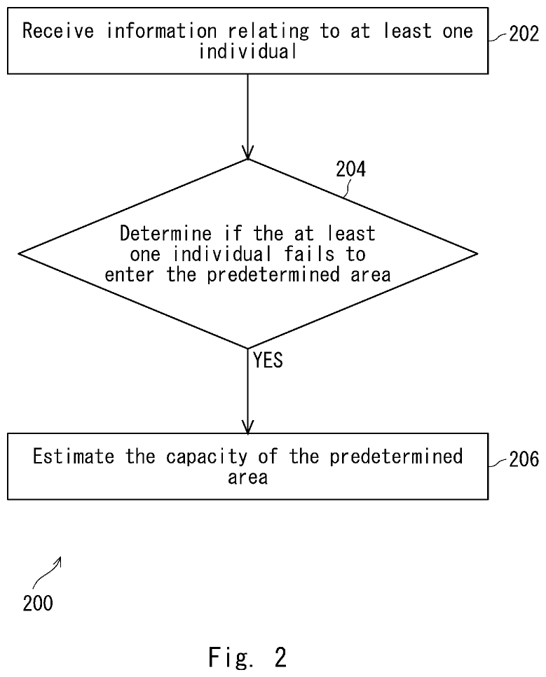

Such a server may be used to implement the method 200 shown in FIG. 2. FIG. 2 shows a flowchart illustrating a method 200 for adaptively estimating the capacity of the predetermined area of the vehicle in accordance with embodiments of the invention.

Various embodiments of this invention solve the non-reserved transportation passenger congestion problem by providing information of available room of each gate or train cabin by detecting information of the individuals at each gate of train cabin.

Advantageously, this allows the least computer resources to be used since typically one sensor and one server are required at each gate. It is not necessary to require in-train devices. That is, it is not necessary to analyze passengers' in and out flow for each cabin to estimate capacity utilization at each station, which requires a lot of image processing computation and dedicated high resolution cameras for each gate.

Also, various embodiments require minimum data processing and communication bandwidth since the information that is detected at the gate is sent to a processing server. That is, according to various embodiments, a large amount of data is not required to be transferred back to a centralised system from a plurality of sensors inside each cabin of a single train.

Additionally, the minimum number of devices used provides lower maintenance of hardware and software. For example, it is not necessary to calibrate analytic software or firmware for deployment or setup. Moreover, reduced efforts are required to upgrade sensors' hardware as well as its software or firmware.

The method 200 broadly includes:

Step 202: receiving, by the server, information relating to at least one individual who is positioned at an entrance to enter the predetermined area of the vehicle.

Step 204: determining, by the server, if the at least one individual fails to enter the predetermined area of the vehicle at a location in response to receiving the information.

Step 206: estimating, by the server, the capacity of the predetermined area of the vehicle when it is determined that the at least one individual fails to enter the predetermined area of the vehicle.

At step 204, the method 200 for adaptively estimating capacity of a predetermined area of a vehicle includes receiving information indicating that the entrance to enter the predetermined area of the vehicle is closing. In an embodiment, it is determined if the at least one individual fails to enter the predetermined area of the vehicle in response to the receipt of the information indicating that the entrance is closing.

At step 206, the step of estimating the capacity of the predetermined area of the vehicle comprises retrieving historical data relevant to the vehicle at a successive location that is located after the location. The historical data indicates a number or a probability of passengers leaving the predetermined area of the vehicle at the successive location. A a number of individuals who may leave the predetermined area of the vehicle at the successive location is then predicted in response to the historical data. Consequently, the capacity of the predetermined area of the vehicle at the successive location is estimated in response to the prediction of the number of individuals leaving the predetermined area of the vehicle at the successive location.

The results obtained by the steps 202-206 may be sent to one other server that is located at a successive location. That is, the result of the estimation step may be sent to at least one other server (e.g., 102b or 120) that is operationally coupled to the server (e.g., 102a), the at least one other server (e.g., 102b or 120) being configured to estimate capacity of the predetermined area of the vehicle at least one other successive location that is located after the location. The one other server may determine a number of individuals who are positioned at an entrance to enter the predetermined area of the vehicle at the at least one other successive location. The determination may be done in response to the receipt of relevant information relating to individuals who are positioned at the entrance at the at least one other successive location.

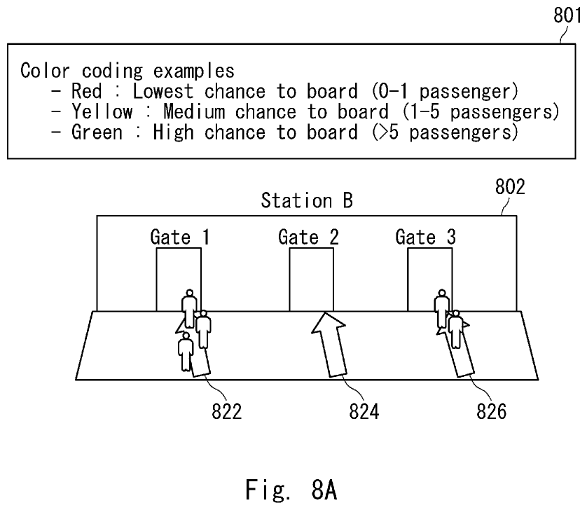

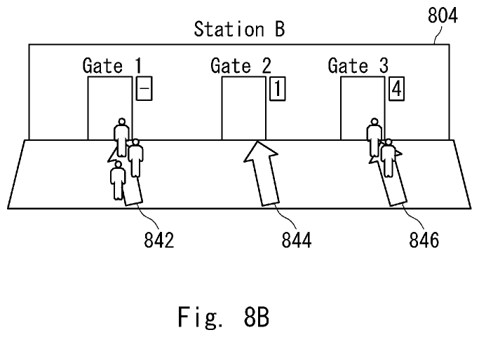

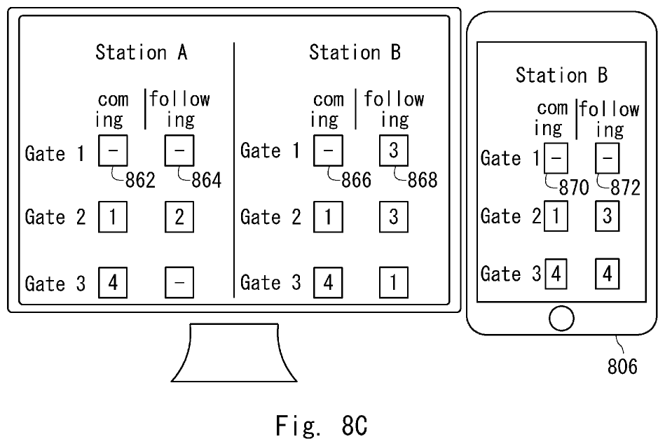

The results of the estimation step in step 206 may be displayed, by the server or the at least one other server, at the location or any of the successive locations. For the purposes of displaying the results of the estimation step, a further determination step may be carried out to determine if the available room for boarding at the cabin of the vehicle is above a predetermined value before displaying the results in a predetermined format. More information will be shown in FIG. 8.

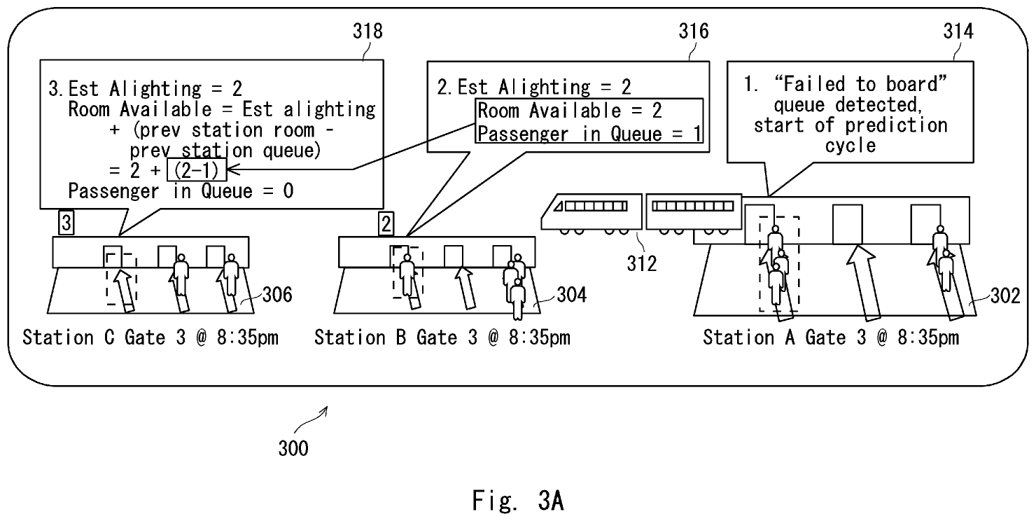

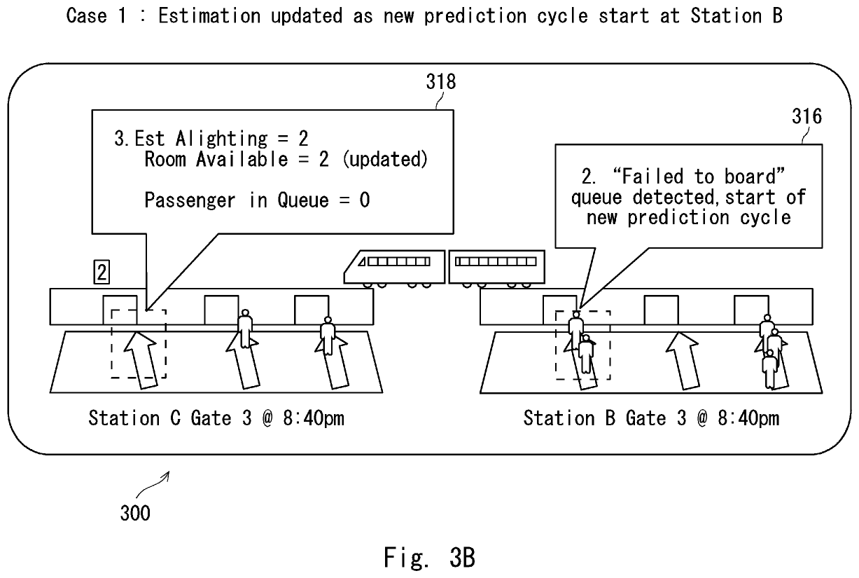

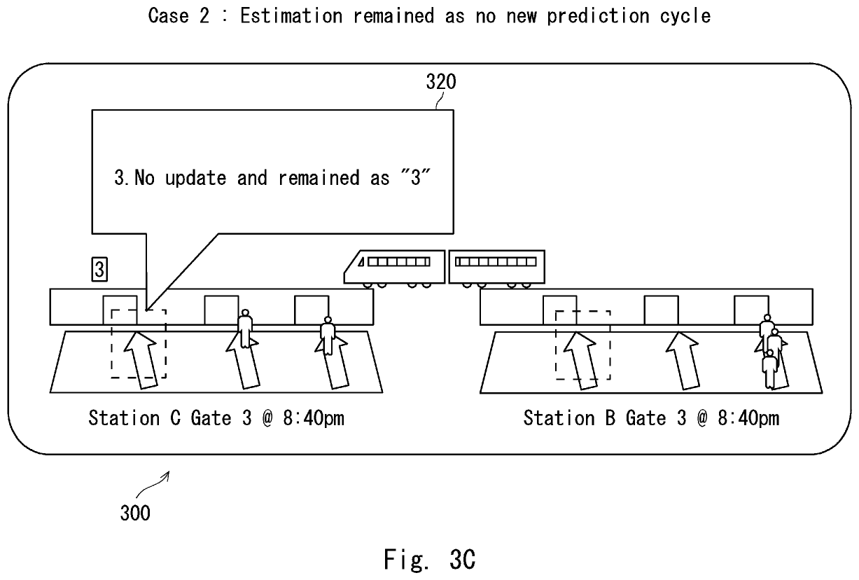

FIGS. 3A-3C show an example as to how capacity of a predetermined area of a vehicle is adaptively estimated in accordance with embodiments of the present invention. FIG. 3A shows that there are a series of successive locations (or train stations) 300, beginning from the first location 302, Station A, then the second location 304, Station B, which is located after the first location (or successive location to Station A). The third location 306, Station C, is located after the second location, Station B (or successive location to Station A and/or Station B).

As shown in FIG. 3A, at 8:35 pm, when it is detected that the gate of a cabin of a non-reserved train 312 is closing, information relating to the individuals standing at the gate will be detected and sent to a server (e.g., server 102 as shown in FIG. 1). In response to the receipt of the information, the server will determine if the at least one individual fails to enter the cabin at a location (e.g., Station A). If it is detected that there are individuals who fail to enter the cabin at Station A (as shown in table 314), the estimation of capacity of the cabin will start as the train 312 leaves Station A and is in transit towards Station B.

At the initiation of the estimation of capacity of the cabin at Station A which is at 8:35 pm, a prediction of number of individuals who may leave the cabin at Station B may be obtained from historical data. As shown in table 316, it may be predicted that 2 individuals will be leaving the cabin of the train 312 at Station B (shown as “Est Alighting=2” in table 316). As such, the available room for boarding the cabin of the train at Station B will be for 2 individuals (shown as “Room Available=2” in table 316). Assuming that the individuals fail to enter the cabin at Station A because it is full, the display at Station B may show that the room available for that cabin is for 2 individuals since 2 individuals are expected to leave the cabin at Station B. A sensor at Station B may detect the presence of individuals standing outside the gate of the cabin. The sensor in this example detect 1 individual is in the queue. In other words, the available room for boarding the cabin of the train 312 will be for 1 individual (which is the difference between the room available and the number of individuals at the gate) when the train 312 is expected to leave the Station B.

At the same time, at 8:35 pm, a prediction of number of individuals who may leave the cabin at Station C may be obtained from historical data. As shown in table 318, it may be predicted that 2 individuals will be leaving the cabin of the train 312 Station C (shown as “Est Alighting=2” in table 318). The available room for boarding the cabin of the train 312 at Station C will be for 3 individuals since the available space in the cabin of the train 312 will be for 1 individual when the train 312 is expected to leave the Station B.

It is to be understood that at 8:35 pm, the train 312 is still in transit between Station A and Station B. At 8:40 pm, the train 312 will be leaving Station B and be in transit between Station B and Station C. There are two possibilities as the train 312 leaves Station B.

FIG. 3B shows the first possibility as the train 312 is leaving Station B at 8:40 pm. At Station B, when it is detected that the gate of a cabin of a non-reserved train 312 is closing, information relating to the individuals standing at the gate will be detected and sent to a server (e.g., server 102 as shown in FIG. 1). In response to the receipt of the information, the server will determine if the at least one individual fails to enter the cabin at Station B. If it is detected that there are individuals who fail to enter the cabin at Station B (as shown in table 316), the estimation of capacity of the cabin will start as the train 312 leaves Station B and is in transit towards Station C. The initiation of the estimation at Station B (or a successive location) is independent of a previous initiation at a previous location (e.g., Station A as shown in FIG. 3A).

At the initiation of the estimation of capacity of the cabin at Station B which is at 8:40 pm, a prediction of number of individuals who may leave the cabin at Station C may be obtained from historical data. As shown in table 318, it may be predicted that 2 individuals will be leaving Station C (shown as “Est Alighting=2” in table 318). The available room for boarding the cabin of the train 312 at Station C will be 2 (instead of “3” as shown in table 318 of FIG. 3A), assuming that the individuals fail to enter the cabin at Station B because it is full.

FIG. 3C shows the second possibility as the train 312 is leaving Station B at 8:40 pm. At Station B, when it is detected that the gate of a cabin of a non-reserved train 312 is closing, information relating to the individuals standing at the gate will be detected and sent to a server (e.g., server 102 as shown in FIG. 1). In response to the receipt of the information, the server will determine if the at least one individual fails to enter the cabin at Station B. If it is detected that there are no individuals who fail to enter the cabin at Station B (as shown in table 316), the available room for boarding the cabin of the train 312 at Station C will remain unchanged as shown in table 318 of FIG. 3A, at 8:35 pm, which is 3 as shown in table 320.

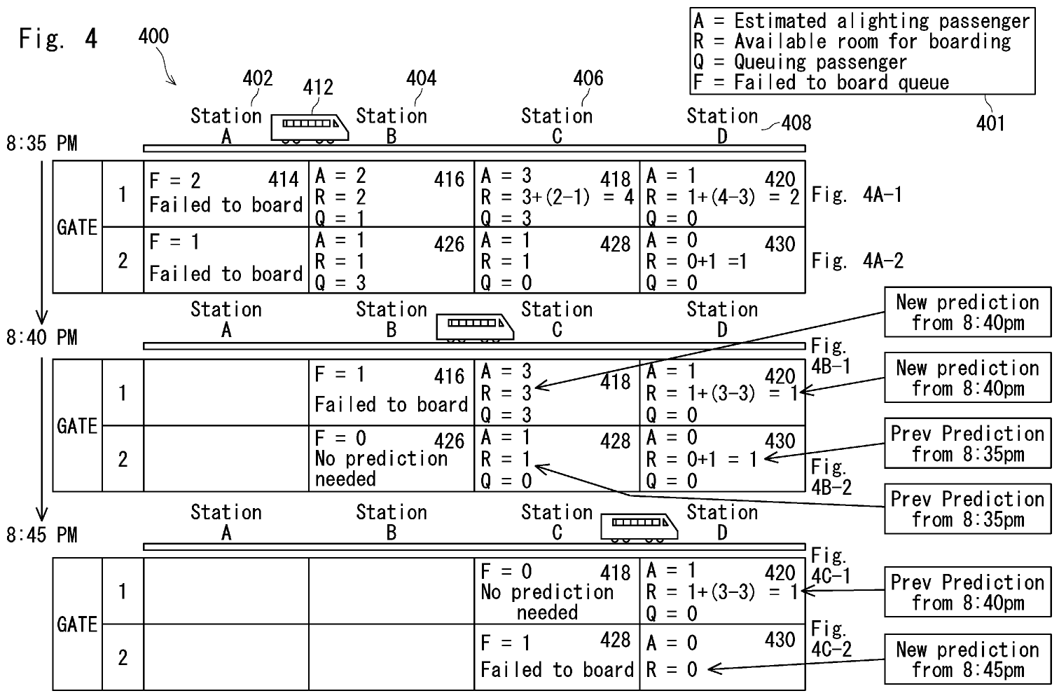

FIG. 4A-1-4C-2 show two examples as to how capacity of a predetermined area of a vehicle is adaptively estimated in accordance with embodiments of the present invention. FIG. 4 shows that there are a series of successive locations (or train stations), beginning from the first location 402, Station A, then the second location 404, Station B, which is located after the first location (or successive location). The third location 406, Station C, is located after the second location, Station B. The fourth location 408, Station D, is located after the third location. Station C.

As shown in FIG. 4A-1, at 8:35 pm, when it is detected that the gate of a cabin of a non-reserved train 412 is closing, information relating to the individuals standing at the gate will be detected and sent to a server (e.g., server 102 as shown in FIG. 1). In response to the receipt of the information, the server will determine if the at least one individual fails to enter the cabin at a location (e.g., Station A). If it is detected that there are individuals who fail to enter the cabin at Station A (shown as “F=1” in table 414, where F represents the number of individuals who failed to board the cabin of the train at that station, as shown in table 401), the estimation of capacity of the cabin will start as the train 412 leaves Station A and is in transit towards Station B.

At the initiation of the estimation of capacity of the cabin at Station A which is at 8:35 pm, a prediction of number of individuals who may leave the cabin at Station B may be obtained from historical data. As shown in table 416, it may be predicted that 2 individuals will be leaving Station B (shown as “A=2” in table 416, where A represents an estimated number of passengers who may alight at that station, as shown in 401). As such, the available room for boarding the cabin at Station B will be for 2 individuals (shown as “R=2” in table 416, where R represents available room for boarding at that station, as shown in 401), assuming that the individuals fail to enter the cabin at Station A because it is full. A sensor at Station B may detect the presence of individuals standing outside the gate of the cabin. The sensor in this example detects 1 individual is in the queue (shown as “Q=1” in table 416, where Q represents the number of queuing passengers, as shown in table 401). In other words, the available room for boarding (“R”) in the cabin of the train 412 will be for 1 individual (which is the difference between the room available and the number of individuals queuing at the gate) when the train 412 is expected to leave the Station B.

At the same time, at 8:35 pm, a prediction of number of individuals who may leave the cabin of train 412 at Station C may be obtained from historical data. As shown in table 418, it may be predicted that 3 individuals will be leaving Station C (shown as “A=3” in table 418). The available room for boarding the cabin of the train 412 at Station C will be 4 (shown as “R=4” in table 418) since the available space in the cabin of the train 412 will be for 1 individual when the train 412 is expected to leave the Station B. A sensor at Station C may detect the presence of individuals standing outside the gate of the cabin. The sensor in this example detects 3 individuals are in the queue (shown as “Q=3” in table 418). In other words, the available room for boarding (“R”) in the cabin of the train 412 will be for 1 individual (which is the difference between the room available and the number of individuals queuing at the gate) when the train 412 is expected to leave Station C.

At the same time, at 8:35 pm, a prediction of number of individuals who may leave the cabin at Station D may be obtained from historical data. As shown in table 420, it may be predicted that 1 individual will be leaving the cabin at Station D (shown as “A=1” in table 420). The available room for boarding the cabin of the train 412 at Station D will be for 2 individuals (shown as “R=2” in table 420) since the available room in the cabin of the train 412 will be for 1 individual when the train 412 is expected to leave the Station C and 1 individual is expected to leave the cabin at Station C.

It is to be understood that at 8:35 pm, the train 412 is still in transit between Station A and Station B. At 8:40 pm, the train 412 will be leaving Station B and be in transit between Station B and Station C.

FIG. 4B-1 shows the train 412 leaving Station B at 8:40 pm. At Station B, when it is detected that the gate of a cabin of a non-reserved train 412 is closing, information relating to the individuals standing at the gate will be detected and sent to a server (e.g., server 102 as shown in FIG. 1). In response to the receipt of the information, the server will determine if the at least one individual fails to enter the cabin at Station B. If it is detected that there are individuals who fail to enter the cabin at Station B (shown as “F=1” in table 416, where F represents the number of individuals who failed to board the cabin of the train at that station, as shown in table 401). The estimation of capacity of the cabin will start as the train 412 leaves Station B and is in transit towards Station C.

At the initiation of the estimation of capacity of the cabin at Station B which is at 8:40 pm, a prediction of number of individuals who may leave the cabin at Station C may be obtained from historical data. As shown in 418, it may be predicted that 3 individuals will be leaving Station C (shown as “A=3” in 418). The available room for boarding the cabin of the train 412 at Station C will be 3 (instead of “4” as shown in table 418 of FIG. 4A-1), assuming that the individuals fail to enter the cabin at Station B because it is full. In other words, there will not be any available room for any individual in the cabin of the train 412 as the train is expected to leave Station C.

At the same time, at 8:40 pm, a prediction of number of individuals who may leave the cabin at Station D may be obtained from historical data. As shown in table 420, it may be predicted that 1 individual will be leaving the cabin of the train 412 at Station D (shown as “A=1” in table 420). The available room for boarding the cabin of the train 412 at Station D will be 1 since the available space in the cabin of the train 412 will not be enough for any individual (R=0) when the train 412 is expected to leave the Station C. The available room for boarding the cabin of the train 412 as it is expected to leave Station C is obtained by determining a difference between room available for boarding at the cabin at Station C and the predicted number of individuals leaving the cabin at Station C. A sensor at Station D may detect the presence of individuals standing outside the gate of the cabin. The sensor in this example detects no individual is in the queue (shown as “Q=0” in 420).

It is to be understood that at 8:40 pm, the train 412 is still in transit between Station B and Station C. At 8:45 pm, the train 412 will be leaving Station C and be in transit between Station C and Station D.

As shown in FIG. 4C-1, at 8:45 pm, when it is detected that the gate of a cabin of the train 412 is closing at Station C, information relating to the individuals standing at the gate will be detected and sent to a server (e.g., server 102 as shown in FIG. 1). In response to the receipt of the information, the server will determine if the at least one individual fails to enter the cabin at Station C. If it is detected that there are no individuals who fail to enter the cabin at Station C (as shown as “F=0” in table 418 of FIG. 4C-1), the room available at Station D will remain unchanged as shown in table 420 of FIG. 4B-1, at 8:35 pm, which is 0.

As shown in FIG. 4B-1, at 8:35 pm, when it is detected that the gate of a cabin of a non-reserved train 412 is closing, information relating to the individuals standing at the gate will be detected and sent to a server (e.g., server 102 as shown in FIG. 1). In response to the receipt of the information, the server will determine if the at least one individual fails to enter the cabin at a location (e.g., Station A). If it is detected that there are individuals who fail to enter the cabin at Station A (shown as “F=1” in table 426, where F represents the number of individuals who failed to board the cabin of the train at that station, as shown in table 401), the estimation of capacity of the cabin will start as the train 412 leaves Station A and is in transit towards Station B.

At the initiation of the estimation of capacity of the cabin at Station A which is at 8:35 pm, a prediction of number of individuals who may leave the cabin at Station B may be obtained from historical data. As shown in table 426, it may be predicted that 1 individual will be leaving Station B (shown as “A=1” in table 426, where A represents an estimated number of passengers who may alight at that station, as shown in 401). As such, the available room for boarding the cabin at Station B will be for 1 individual (shown as “R=1” in table 426, where R represents available room for boarding at that station, as shown in table 401), assuming that the individuals fail to enter the cabin at Station A because it is full. A sensor at Station B may detect the presence of individuals standing outside the gate of the cabin. The sensor in this example detects 3 individuals are in the queue (shown as “Q=3” in table 426, where Q represents the number of queuing passengers, as shown in table 401). In other words, the available room for boarding (“R”) in the cabin of the train 412 will not be enough for any individual (R=0 when the train 412 is expected to leave the Station B). The available room for boarding the cabin of the train 412 as it is expected to leave Station B is obtained by determining a difference between room available for boarding at the cabin at Station B and the predicted number of individuals leaving the cabin at Station B. A sensor at Station B may detect the presence of individuals standing outside the gate of the cabin. The sensor in this example detect 3 individual is in the queue (shown as “Q=3 in 426).

At the same time, at 8:35 pm, a prediction of number of individuals who may leave the cabin of train 412 at Station C may be obtained from historical data. As shown in table 428, it may be predicted that 1 individual will be leaving Station C (shown as “A=1” in table 428). The available room for boarding the cabin of the train 412 at Station C will be for 1 individual (shown as “R=1” in table 428). The available room for boarding the cabin of the train 412 as it is expected to leave Station C is obtained by determining a difference between room available for boarding at the cabin at Station C and the predicted number of individuals leaving the cabin at Station C. A sensor at Station C may detect the presence of individuals standing outside the gate of the cabin. The sensor in this example detects no individual is in the queue (shown as “Q=0” in table 428). Hence, in this example, the available room for boarding the cabin at the train 412 will be for 1 individual as the train 412 is expected to leave Station C.

At the same time, at 8:35 pm, a prediction of number of individuals who may leave the cabin at Station D may be obtained from historical data. As shown in table 430, it may be predicted that no individual will be leaving the cabin at Station D (shown as “A=0” in table 430). The available room for boarding the cabin of the train 412 will be for 1 individual (shown as “R=1” in table 430) since the available room in the cabin of the train 412 will be for 1 individual when the train 412 is expected to leave the Station C and 0 individual is expected to leave the cabin at Station C.

It is to be understood that at 8:35 pm, the train 412 is still in transit between Station A and Station B. At 8:40 pm, the train 412 will be leaving Station B and be in transit between Station B and Station C.

FIG. 4B-2 shows the train 412 leaving Station B at 8:40 pm. At Station B, when it is detected that the gate of a cabin of a non-reserved train 412 is closing, information relating to the individuals standing at the gate will be detected and sent to a server (e.g., server 102 as shown in FIG. 1). In response to the receipt of the information, the server will determine if the at least one individual fails to enter the cabin at Station B. If it is detected that there is no individual who fails to enter the cabin at Station B (shown as “F=0” in table 426), the available room for boarding the cabin of the train 412 at Station C and Station D will remain unchanged as shown in table 428 and table 430 of FIG. 4B-1, at 8:35 pm, which is R=1 and R=1, respectively.

It is to be understood that at 8:40 pm, the train 412 is still in transit between Station B and Station C. At 8:45 pm, the train 412 will be leaving Station C and be in transit between Station C and Station D.

As shown in FIG. 4C-2, at 8:45 pm, when it is detected that the gate of a cabin of the train 412 is closing at Station C, information relating to the individuals standing at the gate will be detected and sent to a server (e.g., server 102 as shown in FIG. 1). In response to the receipt of the information, the server will determine if the at least one individual fails to enter the cabin at Station C. If it is detected that there are individuals who fail to enter the cabin at Station C (as shown as “F−1” in table 428 of FIG. 4C-2), the estimation of capacity of the cabin will start as the train 412 leaves Station C and is in transit towards Station D.

At the initiation of the estimation of capacity of the cabin at Station C which is at 8:45 pm, a prediction of number of individuals who may leave the cabin at Station D may be obtained from historical data. As shown in table 430, it may be predicted that no individual will be leaving the cabin at Station D (shown as “A=0” in table 430 as shown in FIG. 4C-2). The available room for boarding the cabin of the train 412 at Station D will be 0 (instead of “1” as shown in table 430 of FIG. 4B-2), assuming that the individuals fail to enter the cabin at Station C because it is full.

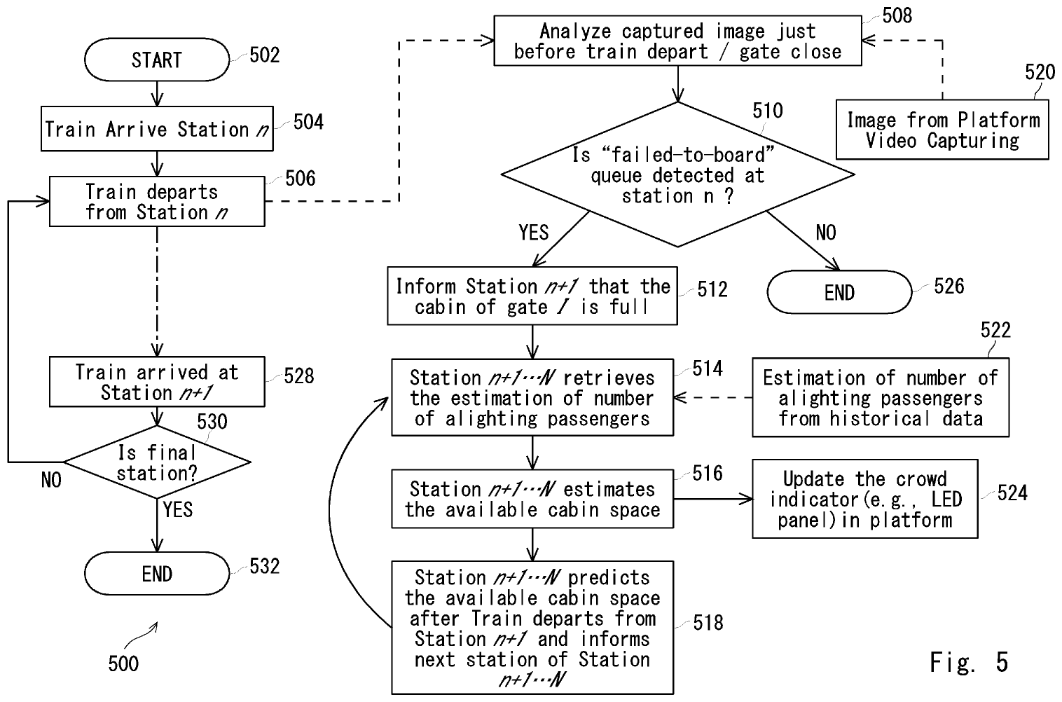

FIG. 5 shows a flow chart 500 illustrating how capacity of a predetermined area of a vehicle may be estimated in accordance with embodiments of the invention. In various embodiments, the predetermined area of a vehicle refers to available room for boarding the cabin. In an example, the steps in the flow chart 500 may be carried out by the server 102 or server 120, shown in FIG. 1. At step 502, a vehicle (e.g. a train) begins its trip as planned by the transport provider. At step 504, it is determined whether or not the train has arrived at a station. Station n, (or a location). At step 506, it is determined whether or not the train has departed from the station (or a location). Step 506 may be triggered by a detection that a gate (or entrance) to the cabin (or predetermined area) is closing at Station n.

At step 508, images that are captured just before the train departs or before the gate closes will be analysed. That is, information relating to the individuals (or images of individuals that are captured) just before the train departs or before the gate closes will be analysed. These images may be obtained from a sensor or an image capturing device that is placed at a platform of the location as shown in table 520.

At step 510, a determination operation to determine whether or not there is a “failed-to-board” queue at the station in response to the analysis of the captured images in step 508. At step 512, if it is determined that there is a “failed-to-board” queue at the station, Station n, the next successive station, Station n+1, will be informed that the cabin is full. In other words, information informing that the there is a “failed-to-board” queue at Station n will be sent to the operating server (e.g. server 102b if server 102a is used for performing steps 508 and 510, or server 110).

At step 514, prediction of a number of alighting passengers at Station n+1 is carried out. The prediction may be done based on historical data that is retrieved as shown in table 522. The historical data relates to the number of alighting passengers at Station n+1 under similar conditions, for example, similar arrival times, month and time. At step 516, the available room for boarding the cabin at Station n+1 will be estimated. Accordingly, the crowd indicator will be updated to display the available room for boarding the cabin at a platform at Station n+1 as shown in table 524. At step 518, an estimation operation, for estimating the available room for boarding the cabin as the train is expected to leave Station n+1, is carried out. Accordingly, the next successive station, e.g., Station n+2, will be informed.

As mentioned above, at step 510, a determination operation to determine whether or not there is a “failed-to-board” queue at the station in response to the analysis of the captured images in step 508. In the event that it is determined that there is no “failed-to-board” queue at the station, Station n, it will be led to step 526 which marks the end of the estimation process.

At step 528, it is determined if the train has reached a successive station, Station n+1. If it is determined that the train has reached the successive station, it is determined if Station n+1 is the final stop at step 530. If it is determined that Station n+1 is not the final stop, it will go back to step 506. If it is determined that Station n+1 is not the final stop, it will be led to step 532 which marks the end of the estimation process.

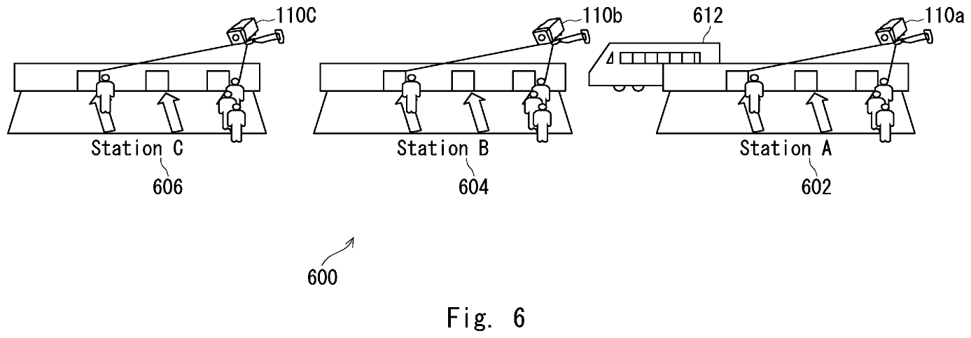

FIG. 6 shows an example as to how capacity of a predetermined area of a vehicle is adaptively estimated using a Markov model in accordance with embodiments of the present invention. FIG. 6 shows that there are a series of successive locations (or train stations) 600, beginning from the first location 602, Station A, then the second location 604, Station B, which is located after the first location (or successive location). The third location 606, Station C, is located after the second location, Station B.

FIG. 6 shows that cameras 110a. 110b and 110c are positioned at a platform of each of the stations, Station A, B and C, respectively. A corresponding server may be operationally coupled to each of these cameras 110a, 110b and 110c. The servers may have a queue monitoring software for processing the captured images from the cameras 110a, 110b and 110c to check a length of a queue or count the number of people queuing at each platform gate. When a train 612 leaves a station (e.g., Station A), if a queue length or number of queuing people is larger than a threshold value (default is 0), the corresponding server (e.g., 110a) at the station estimates the queue length/number of queuing people of each gate, and sends the status to the servers at the successive stations (e.g., Station B and C). When a server of a station (e.g., Station C) receives status from previous stations (e.g., Station A and B), it predicts the available cabin space for each cabin and updates the crowd level indicators of platform gates accordingly.

For example, as the train 612 is leaving Station A, it is determined that there is a queue length that is greater than a threshold value (e.g. default value is 0) in a queue. The server of station A estimates the onboard status based on the queuing status at the platform. In the event that it is determined that there are passengers queuing outside the cabin, it is assumed that the cabin is at maximum capacity as it leaves Station A. The server (e.g., server 102a shown in FIG. 1) at Station A may be configured to send the onboard status (or available room for boarding the cabin) to the server (e.g., server 102b shown in FIG. 1) at the next station, Station B.

A Markov model may be used to estimate the available room for boarding the cabin. According to the Markov model, a probability of a passenger alighting at Station B is needed if it is determined that there is a passenger on board at Station A. Since the probability of a passenger alighting at Station B is based on historical data, it is independent on whether or not the passenger boards the cabin at Station A.

In an embodiment, the server at Station B predicts the available space in the cabin of the train 612 (or estimating capacity of a predetermined area of a vehicle) by:

(the onboard status at Station A) multiplied by (the probability of a passenger alighting at Station B if there is a passenger on board in the cabin at Station A).

In an embodiment, the server at Station B updates the onboard status for this train 612 and sends it to the server at Station C, based on the following:

(onboard status of the cabin as the train is leaving Station A) minus (available space in the cabin of the train calculated by the server at Station B) plus (the number of people queuing for a cabin in the platform at Station B), and capped at the maximal capacity of a cabin.

The server at Station C estimates the available room for boarding the cabin in response to the receipt of the updated onboard status from the server at Station B. The estimated available room for boarding the cabin will be sent from the server at Station to the server at the successive station.

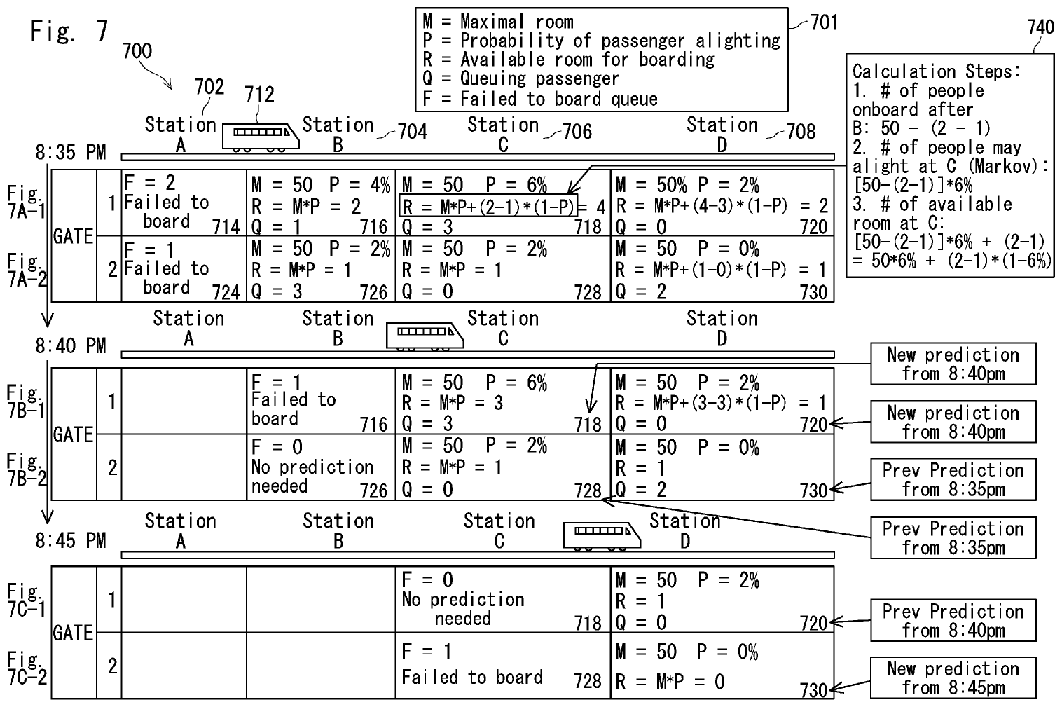

FIG. 7A-1-7C-2 show two examples as to how capacity of a predetermined area of a vehicle is adaptively estimated using a Markov model in accordance with embodiments of the invention. FIG. 7 shows that there are a series of successive locations (or train stations), beginning from the first location 702, Station A, then the second location 704, Station B, which is located after the first location (or successive location). The third location 706, Station C, is located after the second location. Station B. The fourth location 708, Station D, is located after the third location, Station C.

As shown in FIG. 7A-1, at 8:35 pm, when it is detected that the gate of a cabin of a non-reserved train 712 is closing, information relating to the individuals standing at the gate will be detected and sent to a server (e.g., server 102 as shown in FIG. 1). In response to the receipt of the information, the server will determine if the at least one individual fails to enter the cabin at a location (e.g., Station A). If it is detected that there are individuals who fail to enter the cabin at Station A (shown as “F=1” in table 714, where F represents the number of individuals who failed to board the cabin of the train at that station, as shown in table 701), the estimation of capacity of the cabin will start as the train 712 leaves Station A and is in transit towards Station B.

At the initiation of the estimation of capacity of the cabin at Station A which is at 8:35 pm, a probability of number of individuals who may leave the cabin at Station B may be obtained from historical data. As shown in table 716, it may be predicted that a probability of 4% of passengers may leave the cabin at Station B (shown as “P=4%” in table 716, where P represents a probability of passengers alighting or leaving the cabin at that station, as shown in 701). Assuming that there is failed to board queue at Station A because the cabin is at full capacity (shown as “M=50” in table 716, where M represents the maximal room of a cabin as shown in 701), the available room for boarding the cabin at Station B will be for 2 individuals (shown as “R=2” in table 716, where R represents available room for boarding at that station, as shown in 701). The available room for boarding the cabin at Station B may be obtained based on the maximal room of the cabin and the probability of passengers alighting or leaving the cabin at that station (where R=M*P, as shown in 716). A sensor at Station B may detect the presence of individuals standing outside the gate of the cabin. The sensor in this example detects 1 individual is in the queue (shown as “Q=1” in table 716, where Q represents the number of queuing passengers, as shown in table 701). In other words, the available room for boarding (“R”) in the cabin of the train 712 will be for 1 individual (which is the difference between the room available and the number of individuals queuing at the gate) when the train 712 is expected to leave Station B.

At the same time, at 8:35 pm, the available room for boarding the cabin of the train 412 at Station C will be calculated. This can be calculated by taking into consideration:

(i) the number of people onboard the cabin after the train 712 is expected to leave Station B

(shown as “# of people onboard after B=50−(2−1)” in table 740)

(ii) the number of people who may alight from the cabin of train 712

(shown as “# of people may alight at C (Markov)=[50−(2−1)*6%]” in table 740)

As such, the room available for boarding the cabin of the train at Station C is R (shown as “R=4” in table 718 which is obtained from “# of available room at C=[50−(2−1)*6%]+(2−1)=50*6%+(2−1)*(1−6%), which is M*P+(available room for boarding the cabin at the previous station)*(1−P) in table 740). The available room for boarding the cabin of the train 712 at Station B will be for 1 individual when the train 712 is expected to leave the Station B. A sensor at Station C may detect the presence of individuals standing outside the gate of the cabin. The sensor in this example detects 3 individuals are in the queue (shown as “Q=3” in table 718). In other words, the available room for boarding (“R”) in the cabin of the train 712 will be for 1 individual (which is the difference between the room available and the number of individuals queuing at the gate) when the train 712 is expected to leave Station C.

At the same time, at 8:35 pm, a probability of number of individuals who may leave the cabin at Station D may be obtained from historical data. As shown in table 720, it may be predicted that 2% of the passengers will be leaving the cabin at Station D (shown as “P=1%” in table 720). The available room for boarding the cabin of the train 712 at Station D will be for 2 individuals (shown as “R=2” in table 720, which is obtained by R=M*P+(4−3)*(1−P)) since the available room in the cabin of the train 712 will be for 1 individual when the train 712 is expected to leave the Station C.

It is to be understood that at 8:35 pm, the train 712 is still in transit between Station A and Station B. At 8:40 pm, the train 712 will be leaving Station B and be in transit between Station B and Station C.

FIG. 7A-2 shows the train 712 leaving Station B at 8:40 pm. At Station B, when it is detected that the gate of a cabin of a non-reserved train 412 is closing, information relating to the individuals standing at the gate will be detected and sent to a server (e.g., server 102 as shown in FIG. 1). In response to the receipt of the information, the server will determine if the at least one individual fails to enter the cabin at Station B. If it is detected that there are individuals who fail to enter the cabin at Station B (shown as “F=1” in table 716, where F represents the number of individuals who failed to board the cabin of the train at that station, as shown in table 701). The estimation of capacity of the cabin will start as the train 712 leaves Station B and is in transit towards Station C.

At the initiation of the estimation of capacity of the cabin at Station B which is at 8:40 pm, a probability of number of individuals who may leave the cabin at Station C may be obtained from historical data. As shown in 718, it may be predicted that 6% of the individuals will be leaving the cabin at Station C (shown as “P=6%” in 718). The available room for boarding the cabin of the train 712 at Station C will be 3 (instead of “4” as shown in table 418 of FIG. 4A-1), assuming that the individuals fail to enter the cabin at Station B because it is full. The available room for boarding the cabin of the train 712 at Station C is R=3 which is obtained by R=M*P, as shown in 718.

At the same time, at 8:40 pm, a probability of number of individuals who may leave the cabin at Station D may be obtained from historical data. As shown in table 720, it may be predicted that 2% of the individuals will be leaving the cabin of the train 712 at Station D (shown as “P=2%” in table 720). The available room for boarding the cabin of the train 712 at Station D will be 1 since the available space in the cabin of the train 712 will not be enough for any individual (R=0) when the train 712 is expected to leave the Station C. The available room for boarding the cabin of the train 712 as it is expected to leave Station C is obtained by determining a difference between room available for boarding at the cabin at Station C and the predicted number of individuals (=M*P) leaving the cabin at Station C.

The available room for boarding the cabin of the train 712 at Station D will be for 1 individuals (shown as “R=1” in table 720, which is obtained by R=M*P+(3−3)*(1−P)) since the available room in the cabin of the train 712 will be for no individual when the train 712 is expected to leave the Station C. A sensor at Station D may detect the presence of individuals standing outside the gate of the cabin. The sensor in this example detects no individual is in the queue (shown as “Q=0” in 720).

It is to be understood that at 8:40 pm, the train 712 is still in transit between Station B and Station C. At 8:45 pm, the train 712 will be leaving Station C and be in transit between Station C and Station D.

As shown in FIG. 7A-3, at 8:45 pm, when it is detected that the gate of a cabin of the train 712 is closing at Station C, information relating to the individuals standing at the gate will be detected and sent to a server (e.g., server 102 as shown in FIG. 1). In response to the receipt of the information, the server will determine if the at least one individual fails to enter the cabin at Station C. If it is detected that there are no individuals who fail to enter the cabin at Station C (as shown as “F=0” in table 718 of FIG. 7B-3), the room available at Station D will remain unchanged as shown in table 720 of FIG. 7A-2, at 8:35 pm, which is 0 as shown in 720 of FIG. 7A-3.

As shown in FIG. 7A-2, at 8:35 pm, when it is detected that the gate of a cabin of a non-reserved train 712 is closing, information relating to the individuals standing at the gate will be detected and sent to a server (e.g., server 102 as shown in FIG. 1). In response to the receipt of the information, the server will determine if the at least one individual fails to enter the cabin at a location (e.g., Station A). If it is detected that there are individuals who fail to enter the cabin at Station A (shown as “F=1” in table 724, where F represents the number of individuals who failed to board the cabin of the train at that station, as shown in table 701), the estimation of capacity of the cabin will start as the train 712 leaves Station A and is in transit towards Station B.

At the initiation of the estimation of capacity of the cabin at Station A which is at 8:35 pm, a probability of individuals who may leave the cabin at Station B may be obtained from historical data. As shown in table 726, it may be predicted that a probability of 2% of passengers may leave the cabin at Station B (shown as “P=2%” in table 726, where P represents a probability of passengers alighting or leaving the cabin at that station, as shown in 701). Assuming that there is failed to board queue at Station A because the cabin is at full capacity (shown as “M=50” in table 726, where M represents the maximal room of a cabin as shown in 701), the available room for boarding the cabin at Station B will be for 1 individuals (shown as “R=1” in table 716, where R represents available room for boarding at that station, as shown in 701). The available room for boarding the cabin at Station B may be obtained based on the maximal room of the cabin and the probability of passengers alighting or leaving the cabin at that station (where R=M*P, as shown in 726). A sensor at Station B may detect the presence of individuals standing outside the gate of the cabin. The sensor in this example detects 1 individual is in the queue (shown as “Q=3” in table 726, where Q represents the number of queuing passengers, as shown in table 701). In other words, the available room for boarding (“R”) in the cabin of the train 712 will not be enough for any individual (which is the difference between the room available and the number of individuals queuing at the gate) when the train 712 is expected to leave Station B.

At the same time, at 8:35 pm, a probability of number of individuals who may leave the cabin at Station C may be obtained from historical data. As shown in table 728, it may be predicted that 2% of the passengers will be leaving the cabin at Station C (shown as “P=2%” in table 728). The available room for boarding the cabin of the train 712 at Station C will be for 1 individual (shown as “R=1” in table 728, which is obtained by R=M*P) since the available room in the cabin of the train 712 will not be enough for any individuals when the train 712 is expected to leave the Station B. That is, the train 712 will be at maximum capacity when it is expected to arrive at Station C, hence the available room in the cabin of the train 712 at Station C is the number of individuals who are expected to alight from the cabin of the train 712. A sensor at Station C may detect the presence of individuals standing outside the gate of the cabin. The sensor in this example detects no individual in the queue (shown as “Q=0” in table 728). In other words, the available room for boarding (“R”) in the cabin of the train 712 will be for 1 individual (which is the difference between the room available and the number of individuals queuing at the gate) when the train 712 is expected to leave Station C.

At the same time, at 8:35 pm, a probability of number of individuals who may leave the cabin at Station D may be obtained from historical data. As shown in table 730, it may be predicted none of the passengers will be leaving the cabin at Station D (shown as “P=0%” in table 730). The available room for boarding the cabin of the train 712 at Station D will be for 1 individuals (shown as “R=1” in table 730, which is obtained by R=M*P+(1−0)*(1−P)) since the available room in the cabin of the train 712 will be for 1 individual when the train 712 is expected to leave the Station C.

It is to be understood that at 8:35 pm, the train 712 is still in transit between Station A and Station B. At 8:40 pm, the train 712 will be leaving Station B and be in transit between Station B and Station C.

FIG. 7B-2 shows the train 712 leaving Station B at 8:40 pm. At Station B, when it is detected that the gate of a cabin of a non-reserved train 712 is closing, information relating to the individuals standing at the gate will be detected and sent to a server (e.g., server 102 as shown in FIG. 1). In response to the receipt of the information, the server will determine if the at least one individual fails to enter the cabin at Station B. If it is detected that there is no individual who fails to enter the cabin at Station B (shown as “F=0” in table 726), the available room for boarding the cabin of the train 712 at Station C and Station D will remain unchanged as shown in table 728 and table 730 of FIG. 7B-2, at 8:35 pm, which is R=1 and R=1, respectively.

It is to be understood that at 8:40 pm, the train 412 is still in transit between Station B and Station C. At 8:45 pm, the train 412 will be leaving Station C and be in transit between Station C and Station D.

As shown in FIG. 7C-2, at 8:45 pm, when it is detected that the gate of a cabin of the train 712 is closing at Station C, information relating to the individuals standing at the gate will be detected and sent to a server (e.g., server 102 as shown in FIG. 1). In response to the receipt of the information, the server will determine if the at least one individual fails to enter the cabin at Station C. If it is detected that there are individuals who fail to enter the cabin at Station C (as shown as “F−1” in table 728 of FIG. 7C-2), the estimation of capacity of the cabin will start as the train 712 leaves Station C and is in transit towards Station D.

At the initiation of the estimation of capacity of the cabin at Station C which is at 8:45 pm, probability of number of individuals who may leave the cabin at Station D may be obtained from historical data. As shown in table 730, it may be predicted 0% of the individual will be leaving the cabin at Station D (shown as “P=0%” in table 730 as shown in FIG. 7C-2). The available room for boarding the cabin of the train 712 at Station C will be 0 (instead of “1” as shown in table 730 of FIG. 7B-2), assuming that the individuals fail to enter the cabin at Station C because it is full.

FIGS. 8A-8C show an example as to how capacity of a predetermined area of a vehicle is displayed in accordance with embodiments of the present invention. FIG. 8 shows that there is a corresponding colour code to represent a corresponding indication of available room for boarding at a corresponding gate of the train. As shown in table 801, red colour may be used to represent a low chance for an individual to board a cabin. That is, red colour may be used when the available room for boarding the cabin at the train is for 0-1 passenger. As shown in table 801, yellow colour may be used to represent a medium chance for an individual to board a cabin. That is, yellow colour may be used when the available room for boarding the cabin at the train is for 1-5 passengers. As shown in table 801, green colour may be used to represent a high chance for an individual to board a cabin. That is, green colour may be used when the available room for boarding the cabin at the train is for more than 5 passengers. FIGS. 8A-8C show the results of the estimation step (e.g., available room for boarding the cabin at the train) in a predetermined format when it is determined that the result of the estimation step is above the predetermined value.

As shown in FIG. 8A, the colour code may be displayed on the floor of the platform at a station. That is, a floor indicator 822, 824, 826 may be displayed (e.g., a type of a predetermined format) in a colour based on whether or not the available room for boarding the cabin at the train is above a predetermined value. For example, if the available room for boarding the cabin at the train is for more than 5 individuals, then the floor indicator 822, 824, 826 may be displayed in green colour.

As shown in FIG. 8B, the colour code may be displayed at a corresponding entrance of the platform at a station. That is, a gate indicator 842, 844, 846 may be displayed (e.g., a type of a predetermined format) in a colour based on whether or not the available room for boarding the cabin of the train is above a predetermined value (e.g., the predetermined value is 5). For example, if the available room for boarding the cabin at the train is for more than 5 individuals, then the floor indicator 842, 844, 846 may be displayed in green colour.

As shown in FIG. 8C, the colour code may be displayed for a corresponding cabin of a train via a mobile or a web application. That is, an indicator 862, 870 may be displayed (e.g., a type of a predetermined format) in a colour based on whether or not the available room for boarding a cabin (e.g., gate 1) of the immediate on-coming train is above a predetermined value (e.g., the predetermined value is 5). For example, if the available room for boarding the cabin of the immediate on-coming train is for more than 5 individuals, then the indicator 862, 870 may be displayed in green colour. Alternatively or additionally, an indicator 864, 872 may be displayed (e.g. a type of a predetermined format) in a colour based on whether or not the available room for boarding a cabin (e.g., gate 1) of the following train (e.g., the train that follows the immediate on-going train) is above a predetermined value (e.g., the predetermine value is 5). For example, if the available room for boarding the cabin of the following train is for more than 5 individuals, then the indicator 864, 872 may be displayed in green colour.

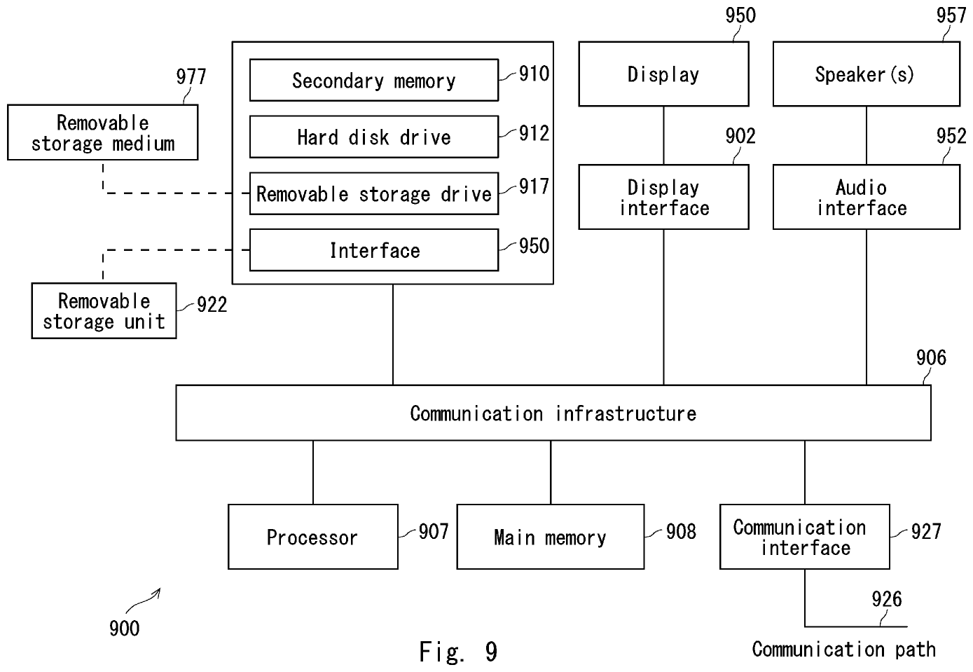

FIG. 9 depicts an exemplary computing device 900, hereinafter interchangeably referred to as a computer system 900, where one or more such computing devices 900 may be used to execute the method of FIG. 2. The exemplary computing device 900 can be used to implement the system 100 shown in FIG. 1. The following description of the computing device 900 is provided by way of example only and is not intended to be limiting.

As shown in FIG. 9, the example computing device 900 includes a processor 907 for executing software routines. Although a single processor is shown for the sake of clarity, the computing device 900 may also include a multi-processor system. The processor 907 is connected to a communication infrastructure 906 for communication with other components of the computing device 900. The communication infrastructure 906 may include, for example, a communications bus, cross-bar, or network.

The computing device 900 further includes a main memory 908, such as a random access memory (RAM), and a secondary memory 910. The secondary memory 910 may include, for example, a storage drive 912, which may be a hard disk drive, a solid state drive or a hybrid drive and/or a removable storage drive 917, which may include a magnetic tape drive, an optical disk drive, a solid state storage drive (such as a USB flash drive, a flash memory device, a solid state drive or a memory card), or the like. The removable storage drive 917 reads from and/or writes to a removable storage medium 977 in a well-known manner. The removable storage medium 977 may include magnetic tape, optical disk, non-volatile memory storage medium, or the like, which is read by and written to by removable storage drive 917. As will be appreciated by persons skilled in the relevant art(s), the removable storage medium 977 includes a computer readable storage medium having stored therein computer executable program code instructions and/or data.

In an alternative implementation, the secondary memory 910 may additionally or alternatively include other similar means for allowing computer programs or other instructions to be loaded into the computing device 900. Such means can include, for example, a removable storage unit 922 and an interface 950. Examples of a removable storage unit 922 and interface 950 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 922 and interfaces 950 which allow software and data to be transferred from the removable storage unit 922 to the computer system 900.

The computing device 900 also includes at least one communication interface 927. The communication interface 927 allows software and data to be transferred between computing device 900 and external devices via a communication path 927. In various embodiments of the inventions, the communication interface 927 permits data to be transferred between the computing device 900 and a data communication network, such as a public data or private data communication network. The communication interface 927 may be used to exchange data between different computing devices 900 which such computing devices 900 form part an interconnected computer network. Examples of a communication interface 927 can include a modem, a network interface (such as an Ethernet card), a communication port (such as a serial, parallel, printer, GPIB, IEEE 1394, RJ45, USB), an antenna with associated circuitry and the like. The communication interface 927 may be wired or may be wireless. Software and data transferred via the communication interface 927 are in the form of signals which can be electronic, electromagnetic, optical or other signals capable of being received by communication interface 927. These signals are provided to the communication interface via the communication path 927.

As shown in FIG. 9, the computing device 900 further includes a display interface 902 which performs operations for rendering images to an associated display 950 and an audio interface 952 for performing operations for playing audio content via associated speaker(s) 957.

As used herein, the term “computer program product” may refer, in part, to removable storage medium 977, removable storage unit 922, a hard disk installed in storage drive 912, or a carrier wave carrying software over communication path 927 (wireless link or cable) to communication interface 927. Computer readable storage media refers to any non-transitory, non-volatile tangible storage medium that provides recorded instructions and/or data to the computing device 900 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 900. Examples of transitory or non-tangible computer readable transmission media that may also participate in the provision of software, application programs, instructions and/or data to the computing device 900 include radio or infra-red transmission channels as well as a network connection to another computer or networked device, and the Internet or Intranets including e-mail transmissions and information recorded on Websites and the like.

The computer programs (also called computer program code) are stored in main memory 908 and/or secondary memory 910. Computer programs can also be received via the communication interface 927. Such computer programs, when executed, enable the computing device 900 to perform one or more features of embodiments discussed herein. In various embodiments, the computer programs, when executed, enable the processor 907 to perform features of the above-described embodiments. Accordingly, such computer programs represent controllers of the computer system 900.

Software may be stored in a computer program product and loaded into the computing device 900 using the removable storage drive 917, the storage drive 912, or the interface 950. The computer program product may be a non-transitory computer readable medium. Alternatively, the computer program product may be downloaded to the computer system 900 over the communications path 926. The software, when executed by the processor 907, causes the computing device 900 to perform the necessary operations to execute the method 200 as shown in FIG. 2.

It is to be understood that the embodiment of FIG. 9 is presented merely by way of example to explain the operation and structure of the system 100. Therefore, in some embodiments one or more features of the computing device 900 may be omitted. Also, in some embodiments, one or more features of the computing device 900 may be combined together. Additionally, in some embodiments, one or more features of the computing device 900 may be split into one or more component parts.

It will be appreciated that the elements illustrated in FIG. 9 function to provide means for performing the various functions and operations of the servers as described in the above embodiments.

When the computing device 900 is configured to optimize efficiency of a transport provider, the computing system 900 will have a non-transitory computer readable medium having stored thereon an application which when executed causes the computing system 900 to perform steps comprising: receive information relating to at least one individual who is positioned at an entrance to enter the predetermined area of the vehicle; determine if the at least one individual fails to enter the predetermined area of the vehicle at a location in response to receiving the information; and estimate the capacity of the predetermined area of the vehicle when it is determined that the at least one individual fails to enter the predetermined area of the vehicle.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

This application is based upon and claims the benefit of priority from Singapore Patent Application No. 10201705461Q, filed on Jul. 3, 2017, the disclosure of which is incorporated herein in its entirety by reference.

### REFERENCE SIGNS LIST

100 SYSTEM
102 SERVER
110 SENSOR
120 CENTRAL SERVER

1. A method, by a server, for adaptively estimating capacity of a predetermined area of a vehicle, comprising:
receiving, by the server, information relating to at least one individual who is positioned at an entrance to enter the predetermined area of the vehicle;
determining, by the server, if the at least one individual fails to enter the predetermined area of the vehicle at a location in response to receiving the information; and
estimating, by the server, the capacity of the predetermined area of the vehicle when it is determined that the at least one individual fails to enter the predetermined area of the vehicle.

2. The method according to claim 1, wherein the step of estimating the capacity of the predetermined area of the vehicle comprises:
retrieving, by the server, historical data relevant to the vehicle at a successive location that is located after the location, the historical data indicating a number of passengers leaving the predetermined area of the vehicle at the successive location; and
predicting, by the server, a number of individuals leaving the predetermined area of the vehicle at the successive location in response to the historical data.

3. The method according to claim 2, wherein the capacity of the predetermined area of the vehicle at the successive location is estimated in response to the prediction of the number of individuals leaving the predetermined area of the vehicle at the successive location.

4. The method according to claim 1, wherein the step of determining if the at least one individual fails to enter the predetermined area of the vehicle at the location, comprises:
receiving, by the server, information indicating that the entrance to enter the predetermined area of the vehicle is closing,
wherein the determination if the at least one individual fails to enter the predetermined area of the vehicle is performed in response to the receipt of the information indicating that the entrance to enter the predetermined area of the vehicle is closing.

5. The method according to claim 1, wherein the step of determining if the at least one individual fails to enter the predetermined area of the vehicle at the location, comprises:
determining, by the server, if a number of individuals who fail to enter the predetermined area of the vehicle is above a threshold value when it is determined that the at least one individual fails to enter the predetermined area of the vehicle.

6. The method according to claim 2, further comprising sending the result of the estimation step to at least one other server that is operationally coupled to the server, the at least one other server being configured to estimate capacity of the predetermined area of the vehicle at the successive location that is located after the location.

7. The method according to claim 6, further comprising:
determining, by the at least one other server, a number of individuals who are positioned at an entrance to enter the predetermined area of the vehicle at the successive location.

8. The method according to claim 2, further comprising:
displaying, by the server, the result of the estimation step.

9. The method according to claim 8, further comprising:
displaying, by the at least one other server, the result of the estimation step at the vehicle at the other successive location.

10. The method according to claim 8, wherein the step of displaying the result of the estimation step comprises:
determining if the result of the estimation step is above a predetermined value; and
displaying the result of the estimation step in a predetermined format when it is determined that the result of the estimation step is above the predetermined value.

11. An apparatus for adaptively estimating capacity of a predetermined area of a vehicle, the apparatus comprising:
at least one processor; and
at least one memory including computer program code;
the at least one memory and the computer program code configured to, with at least one processor, cause the apparatus at least to:
receive information relating to at least one individual who is positioned at an entrance to enter the predetermined area of the vehicle;
determine if the at least one individual fails to enter the predetermined area of the vehicle at a location in response to receiving the information; and
estimate the capacity of the predetermined area of the vehicle when it is determined that the at least one individual fails to enter the predetermined area of the vehicle.

12. The apparatus according to claim 11, wherein the at least one memory and the computer program code is further configured with the at least one processor to:
retrieve historical data relevant to the vehicle at a successive location that is located after the location, the historical data indicating a number of passengers leaving the predetermined area of the vehicle at the successive location; and
predict a number of individuals leaving the predetermined area of the vehicle at the successive location in response to the historical data.

13. The apparatus according to claim 12, wherein the at least one memory and the computer program code is further configured with the at least one processor to:
estimate the capacity of the predetermined area of the vehicle at the successive location in response to the prediction of the number of individuals leaving the predetermined area of the vehicle at the successive location.

14. The apparatus according to claim 11, wherein the at least one memory and the computer program code is further configured with the at least one processor to:
receive information indicating that the entrance to enter the predetermined area of the vehicle is closing,
wherein the determination if the at least one individual fails to enter the predetermined area of the vehicle is performed in response to the receipt of the information indicating that the entrance to enter the predetermined area of the vehicle is closing.

15. The apparatus according to claim 11, wherein the at least one memory and the computer program code is further configured with the at least one processor to:
determine if a number of individuals who fail to enter the predetermined area of the vehicle is above a threshold value when it is determined that the at least one individual fails to enter the predetermined area of the vehicle.

16. The apparatus according to claim 12, wherein the at least one memory and the computer program code is further configured with the at least one processor to:
send the result of the estimation step to at least one other server that is operationally coupled to the server, the at least one other server being configured to estimate capacity of the predetermined area of the vehicle at least one other successive location that is located after the location.

17. The apparatus according to claim 16, wherein the at least one memory and the computer program code is further configured with the at least one processor to:
determine a number of individuals who are positioned at an entrance to enter the predetermined area of the vehicle at the at least one other successive location.

18. The apparatus according to claim 12, wherein the at least one memory and the computer program code is further configured with the at least one processor to:
displaying the result of the estimation.

19. The apparatus according to claim 16, wherein the at least one memory and the computer program code is further configured with the at least one processor to:
send the result of the estimation to the at least one other server.

20. The apparatus according to claim 18, wherein the at least one memory and the computer program code is further configured with the at least one processor to:
determine if the result of the estimation is above a predetermined value; and
display the result of the estimation in a predetermined format when it is determined that the result of the estimation is above the predetermined value.
